(19) United States
(12) Patent Application Publication
(10) Pub. No.: US 2025/0368385 A1
(43) Pub. Date: Dec. 4, 2025

(54) Tray With Divider Features

(71) Applicant: Graphic Packaging International, LLC, Atlanta, GA (US)

(72) Inventor: Thomas Brink, West Chicago, IL (US)

(21) Appl. No.: 19/223,157

(22) Filed: May 30, 2025

Related U.S. Application Data
(60) Provisional application No. 63/654,207, filed on May 31, 2024.
(60) Provisional application No. 63/667,229, filed on Jul. 3, 2024.

(51) Int. Cl. B65D 5/4805; B31B 50/73; B31B 120/30; B65D 5/26

(52) U.S. Cl. CPC B65D 5/48022; B31B 50/734; B65D 5/26; B31B 2120/302

(57) ABSTRACT

A tray for holding at least one food product includes a plurality of panels extending at least partially around an interior of the tray, the plurality of panels including a front side panel, at least one front end panel, a front bottom panel, at least one divider panel, a back side panel, at least one back end panel, and a back bottom panel, a plurality of end flaps foldably connected to a respective panel of the plurality of panels, and a divider extending upwardly from the front bottom panel and the back bottom panel in the interior of the tray to form a front interior space and a back interior space in the interior of the tray, the divider including the front divider panel and the back divider panel.

### CROSS-REFERENCE TO RELATED APPLICATIONS

The present application claims priority to U.S. Provisional Patent Application No. 63/654,207, filed on May 31, 2024, entitled Tray With Divider Features, and U.S. Provisional Patent Application No. 63/667,229, filed on Jul. 3, 2024, entitled Tray With Divider Features.

### INCORPORATION BY REFERENCE

The disclosures of each of U.S. Provisional Patent Application No. 63/654,207, filed on May 31, 2024, entitled Tray With Divider Features, and U.S. Provisional Patent Application No. 63/667,229, filed on Jul. 3, 2024, entitled Tray With Divider Features, are hereby incorporated by reference for all purposes as if set forth in their entireties.

### BACKGROUND OF THE DISCLOSURE

The present disclosure generally relates to containers for holding at least one food product. In one embodiment, the present disclosure relates to containers in the form of trays for holding at least one food product and that include divider features.

### SUMMARY OF THE DISCLOSURE

According to one aspect, the disclosure is generally directed to a tray for holding at least one food product comprises a plurality of panels extending at least partially around an interior of the tray, the plurality of panels comprising a front side panel, at least one front end panel, a front bottom panel, at least one divider panel, a back side panel, at least one back end panel, and a back bottom panel, a plurality of end flaps foldably connected to a respective panel of the plurality of panels, and a divider extending upwardly from the front bottom panel and the back bottom panel in the interior of the tray to form a front interior space and a back interior space in the interior of the tray, the divider comprising the front divider panel and the back divider panel.

According to another aspect, the disclosure is generally directed to a blank for forming a tray for holding at least one food product, the blank comprising a plurality of panels for extending at least partially around an interior of the tray formed from the blank, the plurality of panels comprising a front side panel, at least one front end panel, a front bottom panel, at least one divider panel, a back side panel, at least one back end panel, and a back bottom panel, and a plurality of end flaps foldably connected to a respective panel of the plurality of panels, the front divider panel and the back divider panel for forming a divider extending upwardly from the front bottom panel and the back bottom panel in the interior of the tray formed from the blank to form a front interior space and a back interior space in the interior of the tray formed from the blank.

According to another aspect, the disclosure is generally directed to a method of forming a tray for holding at least one food product, the method comprising obtaining a blank, the blank comprising a plurality of panels comprising a front side panel, at least one front end panel, a front bottom panel, at least one divider panel, a back side panel, at least one back end panel, and a back bottom panel, and a plurality of end flaps foldably connected to a respective panel of the plurality of panels, positioning the plurality of panels extending at least partially around an interior of the tray, and forming a divider from the front divider panel and the back divider panel such that the divider extends upwardly from the front bottom panel and the back bottom panel in the interior of the tray to form a front interior space and a back interior space in the interior of the tray.

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an exterior surface of a blank for forming a tray according to a first exemplary embodiment of the disclosure.

FIG. 2 is a perspective view of a tray formed from the blank of FIG. 1 according to the first exemplary embodiment of the disclosure.

FIG. 3 is another perspective view of the tray of FIG. 2.

FIG. 4 is a plan view of an exterior surface of a blank for forming a tray according to a second exemplary embodiment of the disclosure.

FIG. 5 is a perspective view of a tray formed from the blank of FIG. 4 according to the second exemplary embodiment of the disclosure.

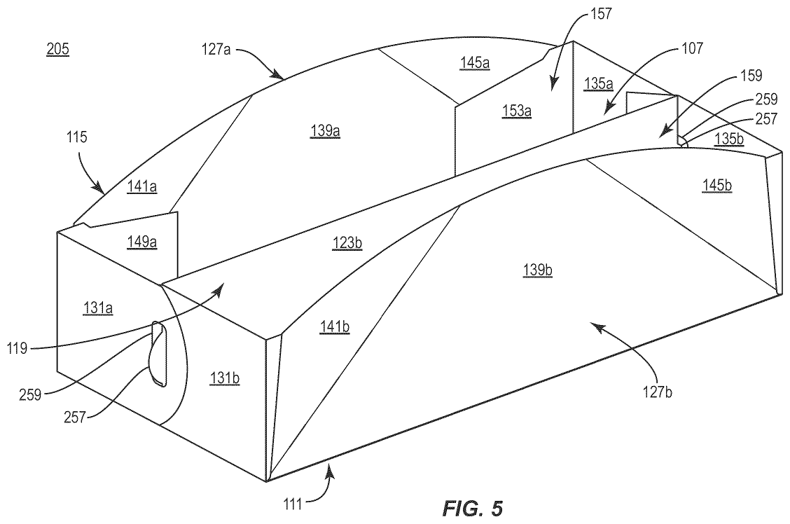

FIG. 6 is another perspective view of the tray of FIG. 5.

Corresponding parts are designated by corresponding reference numbers throughout the drawings.

### DETAILED DESCRIPTION OF THE EXEMPLARY EMBODIMENTS

Containers according to the present disclosure can accommodate containers of numerous different shapes. In this specification, the terms “lower,” “bottom,” “upper,” “top,” “front,” and “back” indicate orientations determined in relation to fully erected containers. As described herein, containers may be formed by multiple overlapping panels, portions, and/or end flaps. Such panels, portions, and/or end flaps may be designated in relative terms to one another, e.g., “first”, “second”, “third”, etc., in sequential or non-sequential reference, without departing from the disclosure.

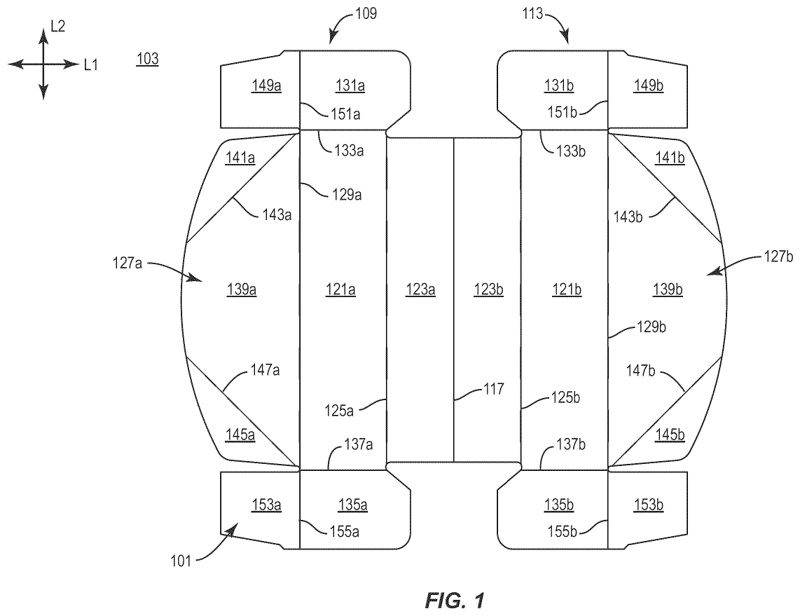

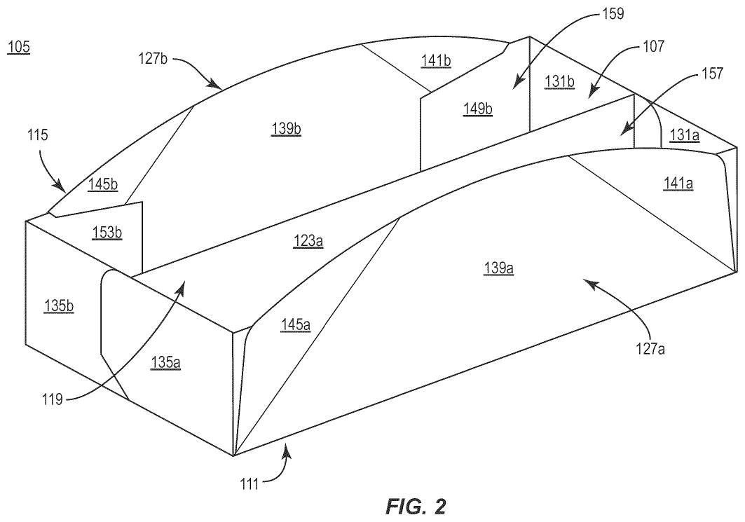

FIG. 1 illustrates an exterior surface 101 of a blank 103 for forming a container in the form of a tray 105 (FIG. 2) according to a first exemplary embodiment of the disclosure. It will be understood that the tray 105 can have a different configuration, for example, a bowl, dish, plate, box, or carton, to name a few.

As described herein, the tray 105 can have an interior 107 that can be used for holding one or more articles such as food products, e.g., portioned retail food products that can include one or more of cookies, crackers, cakes, muffins, pastries, candies, nuts, popcorn, trail mix, gum, etc. In some embodiments, the articles can include frozen or non-frozen food products that can be provided in discrete portions, for example, chicken nuggets, French fries, onion rings, mozzarella sticks, chips, popcorn, other finger foods, tacos, burritos, taquitos, enchiladas, chalupas, quesadillas, churros, etc.

In some embodiments, other types of articles that can include food products and/or non-food products can be placed in the tray 105 for service to a customer. In some embodiments, such products can be contained in additional packaging and then placed in the tray 105. The tray 105 could be otherwise shaped and arranged and could be used to hold other products and/or articles in similar or different environments without departing from the disclosure. In some embodiments, the tray 105 can be provided with one or more food products as a package.

As shown in FIG. 1, the blank 103 has a longitudinal axis L1 and a lateral axis L2. The blank 103 can have a front portion 109 for forming a front portion 111 of the tray 105 formed from the blank 103, and a back portion 113 for forming a back portion 115 of the tray 105 formed from the blank 103.

The blank 103 can include a plurality of panels for at least partially extending around the interior 107 of the tray 105 formed from the blank 103. In the illustrated embodiment, the front portion 109 of the blank 103 can include a front bottom panel 121a, a front divider panel 123a foldably connected to the bottom panel 121a at a lateral fold line 125a, a front side panel 127a (broadly, “front panel’) foldably connected to the bottom panel 121a at a lateral fold line 129a, a first front end panel 131a (broadly, “front side panel’) foldably connected to the bottom panel 121a at a longitudinal fold line 133a, and a second front end panel 135a (broadly, “front side panel’) foldably connected to the bottom panel 121 at a longitudinal fold line 137a.

The front side panel 127a, as shown, can include a base portion 139a foldably connected to the front bottom panel 121a at the lateral fold line 129a, a first distal portion 141a foldably connected to the base portion 139a at an oblique fold line 143a, and a second distal portion 145a foldably connected to the base portion 139a at an oblique fold line 147a.

The blank 103 and the tray 105 formed therefrom can also include a plurality of end flaps foldably connected to a respective panel of the plurality of panels thereof. In the illustrated embodiment, an attachment end flap 149a can be foldably connected to the front end panel 131a at a lateral fold line 151a, and an attachment end flap 153a can be foldably connected to the front end panel 135a at a lateral fold line 155a.

In some embodiments, one or both of the end panels 131a, 135a can be considered end flaps of the plurality of end flaps. In some embodiments, one or both of the end panel 131a/end flap 149a and the end panel 135a/end flap 153a can be considered portions of a single end flap.

In the illustrated embodiment, the features of the back portion 113 of the blank 103 and the back portion 115 of the tray 105 formed therefrom can have features so as to be generally a mirror-image of the corresponding panels, flaps, and portions of the front portion 109 of the blank 103/front portion 111 of the tray 105. Corresponding components (e.g., panels, flaps, fold lines, cuts, etc.) have been designated by corresponding reference numbers that differ by the “a” or “b” suffix, with the “a” components corresponding to the front portion 109 of the blank 103/front portion 111 of the tray 105 and the “b” components corresponding to the back portion 113 of the blank 103/back portion 115 of the tray 105.

In this regard, the back portion 113 of the blank 103/back portion 115 of the tray 105 can include a back bottom panel 121b, a back divider panel 123b, a back side panel 127b (broadly, “back panel’), a first back end panel 131b (broadly, “back side panel’), a second back end panel 135b (broadly, “back side panel’), back end flaps 149b, 153b, and associated features. As shown, the back divider panel 123b can be foldably connected to the back divider panel 123a at a lateral fold line 117 such that the front portion 109 of the blank 103/front portion 111 of the tray 105 can be foldably connected to the back portion 113 of the blank 103/back portion 115 of the tray 105.

The blank 103 and tray 105 formed therefrom can also include divider features for forming a divider 119 in the interior 107 of the tray 105. In the illustrated embodiment, the divider features can include at least one of the front divider panel 123a and the back divider panel 123b.

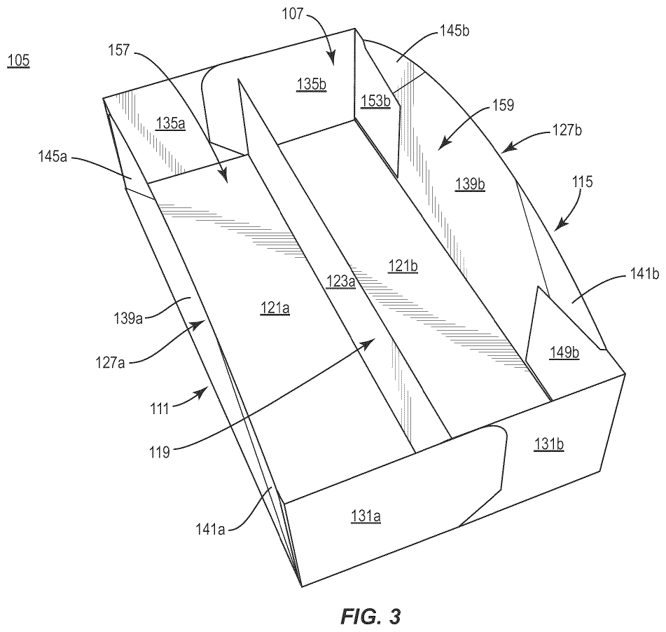

Turning now to FIGS. 2 and 3, formation of the tray 105 from the blank 103 according to an exemplary embodiment of the disclosure will be described. In some embodiments, the blank 103 can be positioned with the exterior surface 101 thereof on a supporting surface, e.g., a table, conveyor, bedplate, etc., and with an interior surface thereof (e.g., planarly opposite the exterior surface 101) facing upwardly.

The front divider panel 123a can be folded at the fold line 125a such that the interior surface thereof is positioned into at least partial face-to-face contact with an interior surface of the bottom panel 121a, e.g., in a backfolded relationship. Thereafter, the exterior surface of the back divider panel 123b can be folded at the fold line 123b into at least partial face-to-face contact with the exterior surface of the front divider panel 123a.

The front side panel 127a can be folded at the fold line 129a into at least partial face-to-face contact with the bottom panel 121a, with the distal portions 141a, 145a folded at the respective fold lines 143a, 147a into at least partial face-to-face contact with the base portion 139a thereof.

The end flaps 149a, 153a can also be folded at the respective fold lines 151a, 155a into at least partial face-to-face contact with the respective end flaps 131a, 135a.

Similarly, the back side panel 127b can be folded at the fold line 129b into at least partial face-to-face contact with the bottom panel 121b, with the distal portions 141b, 145b folded at the respective fold lines 143b, 147b into at least partial face-to-face contact with the base portion 139b thereof.

The end flaps 149b, 153b can also be folded at the respective fold lines 151b, 155b into at least partial face-to-face contact with the respective end flaps 131b, 135b.

The end panels 131a, 135a can be folded at the respective fold lines 133a, 137a to position the end flaps 149a, 153a overlapped thereupon into at least partial face-to-face contact with the interior surfaces of the respective distal portions 141a, 145a of the side panel 127a. Similarly, the end panels 131b, 135b can be folded at the respective fold lines 133b, 137b to position the end flaps 149b, 153b overlapped thereupon into at least partial face-to-face contact with the interior surfaces of the respective base portions 141b, 145b of the side panel 127b.

Such an arrangement of the blank 103 can be considered a collapsed configuration of the tray 105, in which the various panels, end flaps, and features thereof are arranged in a generally low profile planar stacked arrangement so as to present a minimized profile, e.g., for shipping, storage, etc.

In order to further erect the tray 105 from the blank 103, the divider panels 123a, 123b, in at least partial face-to-face contact with one another, can be positioned in generally upright relation relative to the bottom panels 121a, 121b. Such movement can be accompanied by relative folding at one or more of the fold lines 125a, 125b, 117.

The end panels 131a, 131b, 135a, 135b can be at least partially folded at the respective fold lines 133a, 133b, 137a, 137b so as to be positioned in generally upright relation with the respective bottom panels 121a, 121b.

Similarly, the side panels 127a, 127b can be at least partially folded at the respective fold lines 129a, 129b so as to be in at least partially upright relation relative to the bottom panels 121a, 121b.

Such movement of the side panels 121a, 121b can cause the distal portions 141a, 145a of the side panel 127a to at least partially fold at the respective fold lines 143a, 147a into a generally planar arrangement with the base portion 139a thereof. Similarly, the distal portions 141b, 145b of the side panel 127b can at least partially fold at the respective fold lines 143b, 147b into a generally planar arrangement with the base portion 139b thereof.

Due to the generally one-piece construction of the blank 103, the tray 105 can be formed with a simplified process that allows for ease of handling and erection.

An erected configuration of the tray 105 can thus be provided, with the divider panels 123a, 123b forming the divider 119 extending upwardly from the bottom panels 121a, 121b in the interior 107 of the tray 105 to form a front interior space 157 and a back interior space 159 therein.

Each interior space 157, 159 can be configured for holding one or more food products therein, while maintaining at least partial separation thereof via the divider 119 in a stabilized arrangement. In some embodiments, one or more food products can be provided in one interior spaces 157, 159, and an accessory or condiment, e.g., seasonings, sauces, dressings, condiments, etc., can be provided in the other interior space 157, 159.

In some embodiments, the distal portions 141a, 145a of the side panel 127a can be configured to at least partially fold relative to the base portion 139a thereof at the respective fold lines 143a, 147a, for example, to provide a degree of reconfigurability to the front portion 111 of the tray 105 and/or to allow for a variability in volume in the front interior space 157 of the tray 105, e.g., to accommodate larger and/or irregularly-sized food products.

Similarly, the distal portions 141b, 145b of the side panel 127b can be configured to at least partially fold relative to the base portion 139b thereof at the respective fold lines 143b, 147b to provide similar advantages with regard to the back portion 115 of the tray 105.

The aforementioned arrangement of the tray 105 can be provided with one or more applications of an adhesive such as glue. In the illustrated embodiment, one or more applications of glue can be provided on respective exterior surfaces of one or more of the front divider panel 123a and/or the back divider panel 123b, and the end flaps 149a, 149b, 153a, 153b. In some embodiments, the tray 105 can be erected and/or maintained without or with a minimized use of glue. In such embodiments, locking or other engaging features may be used.

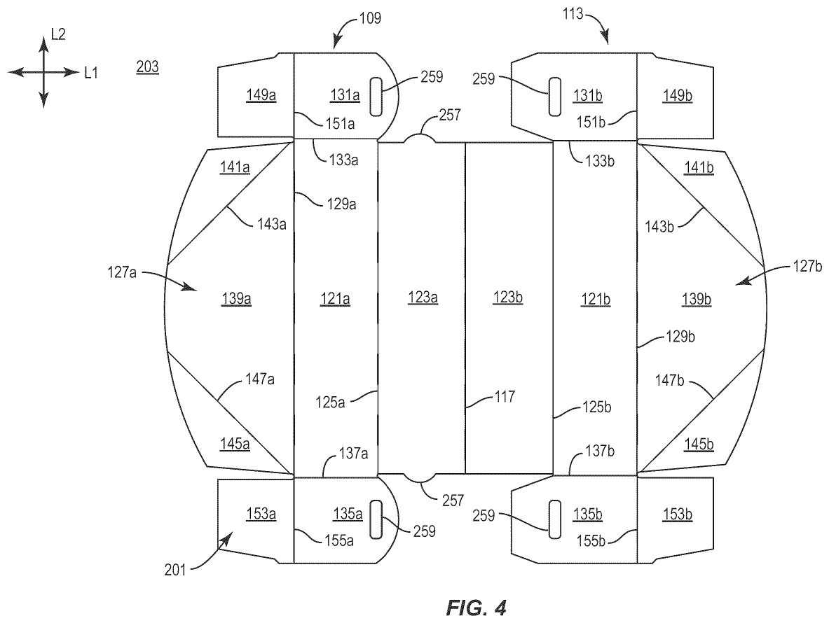

Turning to FIG. 4, the exterior surface 201 of a blank 203 for forming a tray 205 according to a second exemplary embodiment of the disclosure is illustrated. The blank 203 and tray 205 formed therefrom can have one or more features that are the same or similar to those described above with respect to the blank 103 and tray 105, and like or similar features are designated with like or similar reference numerals.

As shown, the blank 203 can have the longitudinal axis L1 and the lateral axis L2, a front portion 209 for forming a front portion 211 of the tray 205 formed from the blank 203, and a back portion 213 for forming a back portion 215 of the tray 205 formed from the blank 203.

The blank 203 can include a plurality of panels for at least partially extending around the interior 207 of the tray 205 formed from the blank 203, which can include the panels 121a, 121b, 123a, 123b, 127a, 127b, 131a, 131b, 135a, 135b, and associated features. The blank 203 and the tray 105 formed therefrom can also include the attachment end flaps 149a, 149b, 153a, 153b and associated features.

The blank 203 and the tray 205 formed therefrom can also include locking features for at least partially maintaining an erected configuration of the tray 205. The locking features can include at least one male locking features extending from a respective panel of the plurality of panels for being at least partially received in at least one female locking features at least partially defined in a respective panel of the plurality of panels.

In the illustrated embodiment, the male locking features can include a respective locking tab 257 (broadly, “first locking tab” or “second locking tab”) extending from opposite free edges of the divider panel 123a. As shown, the locking tab 257 can be a semicircular protrusion extending from the respective portion of the panel 123a in a generally uninterrupted fashion, though it will be understood that one or more lines of weakening can be provided adjacent the respective locking tab 257.

The female locking features can include a respective locking opening 259 at least partially defined in a respective panel 131a, 135a, 131b, 135b (broadly, “first locking opening”, “second locking opening”, “third locking opening”, or “fourth locking opening”). Each locking opening 259, as shown, can have a generally rounded rectangular profile extending partially in the lateral direction L2, though it will be understood that a different number and/or arrangement of locking openings can be provided without departing from the disclosure.

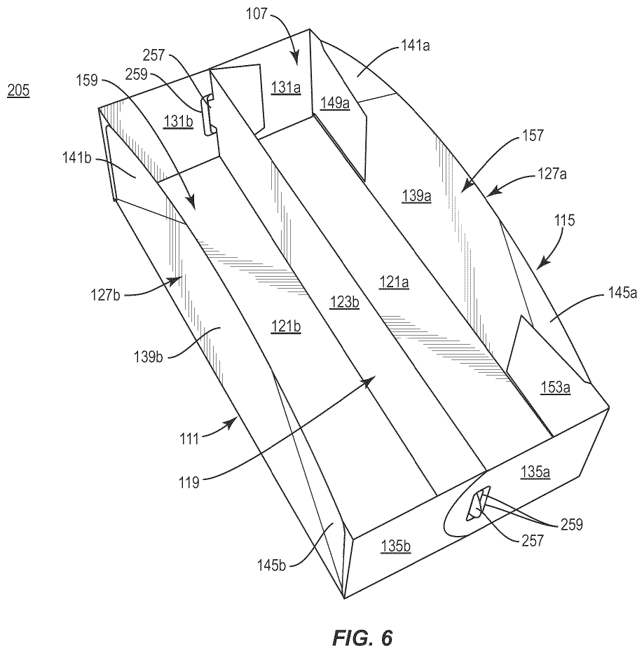

Turning to FIGS. 6 and 7, the tray 205 can be formed from the blank 203 in a manner generally similar to that described above with respect to the formation of the tray 105 from the blank 103.

An erected configuration of the tray 105 can thus be provided the divider panels 123a, 123b forming the divider 119 extending upwardly from the bottom panels 121a, 121b in the interior 107 of the tray 205 to form a front interior space 157 and a back interior space 159 therein, and having advantages and functionality similar to that described above with respect to the tray 105.

However, and as shown, the end panels 131a, 131b can be at least partially overlapped such that the respective locking openings 259 at least partially defined therein are provided in a generally aligned arrangement with each other and an end of the divider 119. In this regard, the aligned locking openings 259 in the end panels 131a, 131b can be positioned to at least partially receive a respective locking tab 257 extending from the divider panel 123a.

Similarly, the end panels 135a, 135b can be at least partially overlapped such that the respective locking openings 259 at least partially defined therein are provided in a generally aligned arrangement with each other and an end of the divider 119 so as to receive a respective locking tab 257 extending from the divider panel 123a.

In some embodiments, the locking tabs 257 can be sized to at least partially engage, e.g., via frictional edge-to-edge contact, respective portions of the end panels 131a, 131b, 135a, 135b that at least partially define the respective locking opening 259 to maintain the formed arrangement of the tray 205.

In some embodiments, the tray 205 can be formed such that the end panels 131a, 131b and the end panels 135a, 135b have a tendency to move apart from one another to produce a slight misalignment in the respective locking openings 259 that can enhance engagement of a respective locking tab 257 therewith.

In some embodiments, one or both of the locking tabs 257 can be provided with features, e.g., hooks, notches, cutouts, barbs, etc., for at least partially engaging a portion of a respective end panel 131a, 131b, 135a, 135b at least partially defining a respective locking opening 259 to at least partially maintain the formed configuration of the tray 205.

It will be understood that a different number and/or arrangement of locking features can be provided without departing from the disclosure.

It will be understood that the blanks and trays described herein can have a different configuration and/or arrangement without departing from the disclosure.

In general, the blanks described herein may be constructed from paperboard having a caliper so that it is heavier and more rigid than ordinary paper. The blanks can also be constructed of other materials, such as cardboard, sheet plastics or any other material having properties suitable for enabling the container to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type of tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the container embodiments. The term “glue” is intended to encompass all manner of adhesives commonly used to secure container panels in place, and is not intended to exclude heat, chemical, or frequency bonding techniques.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A tray for holding at least one food product, the tray comprising:
a plurality of panels extending at least partially around an interior of the tray, the plurality of panels comprising a front side panel, at least one front end panel, a front bottom panel, at least one divider panel, a back side panel, at least one back end panel, and a back bottom panel;
a plurality of end flaps foldably connected to a respective panel of the plurality of panels; and
a divider extending upwardly from the front bottom panel and the back bottom panel in the interior of the tray to form a front interior space and a back interior space in the interior of the tray, the divider comprising the front divider panel and the back divider panel.

2. The tray of claim 1, wherein the at least one divider panel is a front divider panel and the plurality of panels further comprises a back divider panel in at least partial face-to-face contact with the front divider panel.

3. The tray of claim 2, wherein the front divider panel is foldably connected to the back divider panel.

4. The tray of claim 3, wherein the front divider panel is foldably connected to the front bottom panel and the back divider panel is foldably connected to the back bottom panel.

5. The tray of claim 4, wherein the at least one front end panel is foldably connected to the front bottom panel and the at least one back end panel is foldably connected to the back bottom panel.

6. The tray of claim 5, wherein the at least one front end panel is a first front end panel foldably connected to the front bottom panel, the at least one back end panel is a first back end panel foldably connected to the back bottom panel, the plurality of panels further comprises a second front end panel foldably connected to the front bottom panel, and a second back end panel foldably connected to the back bottom panel.

7. The tray of claim 5, wherein at least one of the front side panel or the back side panel comprises a base portion and a plurality of distal portions foldably connected to the base portion.

8. The tray of claim 4, further comprising locking features, the locking features comprising at least one locking tab extending from a respective panel of the plurality of panels at least partially received in a locking opening at least partially defined in a respective panel of the plurality of panels.

9. The tray of claim 8, wherein the at least one locking tab extends from the front divider panel, and the locking opening is at least partially defined in the at least one front end panel.

10. The tray of claim 9, wherein the locking opening is a first locking opening, and the locking features further comprise a second locking opening at least partially defined in the at least one back end panel, the at least one front end panel and the at least one back end panel arranged such that the first locking opening and the second locking opening are aligned, the at least one locking tab at least partially received in the first locking opening and the second locking opening.

11. The tray of claim 10, wherein the at least one front end panel is a first front end panel foldably connected to the front bottom panel, the plurality of panels further comprises a second front end panel foldably connected to the front bottom panel, the at least one locking tab is a first locking tab extending from the front divider panel, the locking features further comprise a third locking opening at least partially defined in the second front end panel and a second locking tab extending from the front divider panel and at least partially received in the third locking opening.

12. The tray of claim 11, wherein the at least one back end panel is a first back end panel and the plurality of panels further comprise a second back end panel foldably connected to the back bottom panel, the locking features further comprise a fourth locking opening at least partially defined in the second back end panel, the second front end panel and the second back end panel arranged such that the third locking opening and the fourth locking opening are aligned, the second locking tab at least partially received in the third locking opening and the fourth locking opening.

13. A blank for forming a tray for holding at least one food product, the blank comprising:
a plurality of panels for extending at least partially around an interior of the tray formed from the blank, the plurality of panels comprising a front side panel, at least one front end panel, a front bottom panel, at least one divider panel, a back side panel, at least one back end panel, and a back bottom panel; and
a plurality of end flaps foldably connected to a respective panel of the plurality of panels,
the front divider panel and the back divider panel for forming a divider extending upwardly from the front bottom panel and the back bottom panel in the interior of the tray formed from the blank to form a front interior space and a back interior space in the interior of the tray formed from the blank.

14. The blank of claim 13, wherein the at least one divider panel is a front divider panel and the plurality of panels further comprises a back divider panel for being positioned in at least partial face-to-face contact with the front divider panel when the tray is formed from the blank.

15. The blank of claim 14, wherein the front divider panel is foldably connected to the back divider panel.

16. The blank of claim 15, wherein the front divider panel is foldably connected to the front bottom panel and the back divider panel is foldably connected to the back bottom panel.

17. The blank of claim 16, wherein the at least one front end panel is foldably connected to the front bottom panel and the at least one back end panel is foldably connected to the back bottom panel.

18. The blank of claim 17, wherein the at least one front end panel is a first front end panel foldably connected to the front bottom panel, the at least one back end panel is a first back end panel foldably connected to the back bottom panel, the plurality of panels further comprises a second front end panel foldably connected to the front bottom panel, and a second back end panel foldably connected to the back bottom panel.

19. The blank of claim 17, wherein at least one of the front side panel or the back side panel comprises a base portion and a plurality of distal portions foldably connected to the base portion.

20. The blank of claim 16, further comprising locking features, the locking features comprising at least one locking tab extending from a respective panel of the plurality of panels for being at least partially received in a locking opening at least partially defined in a respective panel of the plurality of panels when the tray is formed from the blank.

21. The blank of claim 20, wherein the at least one locking tab extends from the front divider panel, and the locking opening is at least partially defined in the at least one front end panel.

22. The blank of claim 21, wherein the locking opening is a first locking opening, and the locking features further comprise a second locking opening at least partially defined in the at least one back end panel, the at least one front end panel and the at least one back end panel for being arranged such that the first locking opening and the second locking opening are aligned when the tray is formed from the blank, the at least one locking tab for being at least partially received in the first locking opening and the second locking opening when the tray is formed from the blank.

23. The blank of claim 22, wherein the at least one front end panel is a first front end panel foldably connected to the front bottom panel, the plurality of panels further comprises a second front end panel foldably connected to the front bottom panel, the at least one locking tab is a first locking tab extending from the front divider panel, the locking features further comprise a third locking opening at least partially defined in the second front end panel and a second locking tab extending from the front divider panel and for being at least partially received in the third locking opening when the tray is formed from the blank.

24. The blank of claim 23, wherein the at least one back end panel is a first back end panel and the plurality of panels further comprise a second back end panel foldably connected to the back bottom panel, the locking features further comprise a fourth locking opening at least partially defined in the second back end panel, the second front end panel and the second back end panel for being arranged such that the third locking opening and the fourth locking opening are aligned when the tray is formed from the blank, the second locking tab for being at least partially received in the third locking opening and the fourth locking opening when the tray is formed from the blank.

25. A method of forming a tray for holding at least one food product, the method comprising:
obtaining a blank, the blank comprising a plurality of panels comprising a front side panel, at least one front end panel, a front bottom panel, at least one divider panel, a back side panel, at least one back end panel, and a back bottom panel, and a plurality of end flaps foldably connected to a respective panel of the plurality of panels;
positioning the plurality of panels extending at least partially around an interior of the tray; and
forming a divider from the front divider panel and the back divider panel such that the divider extends upwardly from the front bottom panel and the back bottom panel in the interior of the tray to form a front interior space and a back interior space in the interior of the tray.

26. The method of claim 25, wherein the at least one divider panel is a front divider panel and the plurality of panels further comprises a back divider panel, the method further comprises positioning the front divider panel in at least partial face-to-face contact with the front divider panel.

27. The method of claim 26, wherein the front divider panel is foldably connected to the back divider panel.

28. The method of claim 27, wherein the front divider panel is foldably connected to the front bottom panel and the back divider panel is foldably connected to the back bottom panel.

29. The method of claim 28, wherein the at least one front end panel is foldably connected to the front bottom panel and the at least one back end panel is foldably connected to the back bottom panel.

30. The method of claim 29, wherein the at least one front end panel is a first front end panel foldably connected to the front bottom panel, the at least one back end panel is a first back end panel foldably connected to the back bottom panel, the plurality of panels further comprises a second front end panel foldably connected to the front bottom panel, and a second back end panel foldably connected to the back bottom panel.

31. The method of claim 29, wherein at least one of the front side panel or the back side panel comprises a base portion and a plurality of distal portions foldably connected to the base portion.

32. The method of claim 28, wherein the blank further comprises locking features, the locking features comprising at least one locking tab extending from a respective panel of the plurality of panels and a locking opening at least partially defined in a respective panel of the plurality of panels, and the method further comprises positioning the at least one locking tab at least partially received in the locking opening.

33. The method of claim 32, wherein the at least one locking tab extends from the front divider panel, and the locking opening is at least partially defined in the at least one front end panel.

34. The method of claim 33, wherein the locking opening is a first locking opening, and the locking features further comprise a second locking opening at least partially defined in the at least one back end panel, the method further comprises arranging the at least one front end panel and the at least one back end panel such that the first locking opening and the second locking opening are aligned, the method further comprising positioning the at least one locking tab at least partially received in the first locking opening and the second locking opening.

35. The method of claim 34, wherein the at least one front end panel is a first front end panel foldably connected to the front bottom panel, the plurality of panels further comprises a second front end panel foldably connected to the front bottom panel, the at least one locking tab is a first locking tab extending from the front divider panel, the locking features further comprise a third locking opening at least partially defined in the second front end panel and a second locking tab extending from the front divider panel, and the method further comprises positioning the second locking tab at least partially received in the third locking opening.

36. The method of claim 35, wherein the at least one back end panel is a first back end panel and the plurality of panels further comprise a second back end panel foldably connected to the back bottom panel, the locking features further comprise a fourth locking opening at least partially defined in the second back end panel, the method further comprising arranging the second front end panel and the second back end panel such that the third locking opening and the fourth locking opening are aligned, the method further comprises positioning the second locking tab at least partially received in the third locking opening and the fourth locking opening.
